(19) United States
(12) Patent Application Publication
(10) Pub. No.: US 2008/0099708 A1
(43) Pub. Date: May 1, 2008

(54) VACUUM VALVE DEVICE FOR A BAG

(76) Inventor: Ti-Tien LEE, Taipei (TW)

Correspondence Address: PATENTTM.US, P. O. BOX 82788, PORTLAND, OR, 97282-0788, US

(21) Appl. No.: 11/552,557

(22) Filed: Oct. 25, 2006

(51) Int. Cl. F16K 51/00

(52) U.S. Cl. 251/144

(57) ABSTRACT

A vacuum valve device is used with a bag and has a base and a clip. The base has a tube, a clipping flange and a valve. The tube mounted through a sheet of the bag and has a central hole and at least one outlet hole. The clipping flange is formed on the tube. The valve is mounted slidably in the tube and selectively seal the at least one outlet hole. The clip is mounted detachably around the tube of the base and cooperates with the clipping flange to hermetically clip the sheet of the bag. The vacuum valve device may be reused, is economical and marketable.

### BACKGROUND OF THE INVENTION

1. Field of the Invention

The present invention relates to a valve device, and more particularly to a vacuum valve device for a bag and that allows the bag to be deflated and sealed so items in the bag are vacuum-packed.

2. Description of Related Art

Plastic bags are non-permeable to water and gas and are used widely to package and preserve items for example quilts, carpets, clothes, and foods such as fish, meat and vegetables.

A conventional plastic bag has an opening and a seal mounted on the opening. After items or foods are packaged in the plastic bag, people may squeeze inside air out of the plastic bag and then close the seal to vacuum-package the items or foods. However, manually squeezing the bag cannot entirely discharge inside air out of the plastic bag. Remaining air inside the plastic bag will oxidize the items and decompose the foods.

To solve the problem that the air remains in the plastic bag, an improved plastic bag with an un-detachable vacuum valve is developed. The vacuum valve is melted and mounted securely on the plastic bag and may be connected to a vacuum pump. The vacuum pump may pump inside air thoroughly out of the plastic bag through the valve so the plastic bag may finely package and preserve items or tools.

However, the plastic bag with the valve has a high cost. Furthermore, the plastic bag has a short life-span and needs to be discarded soon due to the plastic bag is damaged easily or smells after packaging foods such as meat and fishes. People are unwilling to buy such plastic bags with a high cost and a shots life-span. Therefore, the plastic bag with the un-detachable valve is unmarketable.

To overcome the shortcomings, the present invention provides a vacuum valve device for a bag to mitigate or obviate the aforementioned problems.

### SUMMARY OF THE INVENTION

The main objective of the invention is to provide a vacuum valve device for a bag that allows the bag to be deflated and sealed so items in the bag are vacuum-packed.

A vacuum valve device in accordance with the present invention is used with a bag and comprises abase and a clip. The base has a tube, a clipping flange and a valve. The tube amounted through a sheet of the bag and has a central hole and at least one outlet hole. The clipping flange is formed on the tube. The valve is mounted slidably in the tube and selectively seal the at least one outlet hole. The clip is mounted detachably around the tube of the base and cooperates with the clipping flange to hermetically clip the sheet of the bag.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a vacuum valve device in accordance with the present invention mounted on a bag:

FIG. 2 is a perspective view of the vacuum valve device in FIG. 1 with an adapter sleeve;

FIG. 3 is an exploded perspective view of the base of the vacuum valve device in FIG. 2;

FIG. 4 is a partially exploded perspective view of the vacuum valve device in FIG. 2 with one sheet of the bag;

FIG. 5 is a cross sectional side view of the vacuum valve device in FIG. 4 with the sheet mounted securely between the base and the clip and with the valve shaft extending out to open the at least one outlet hole;

FIG. 6 is a cross sectional side view of the vacuum valve device in FIG. 5 with sheet and valve shaft retracting in to seal the at least one outlet hole;

FIG. 7 is a partially exploded perspective view of the vacuum valve device in FIG. 2; and

FIG. 8 is a cross sectional side view of the vacuum valve device in FIG. 7.

### DETAILED DESCRIPTION OF THE PREFERRED EMBODIMENT

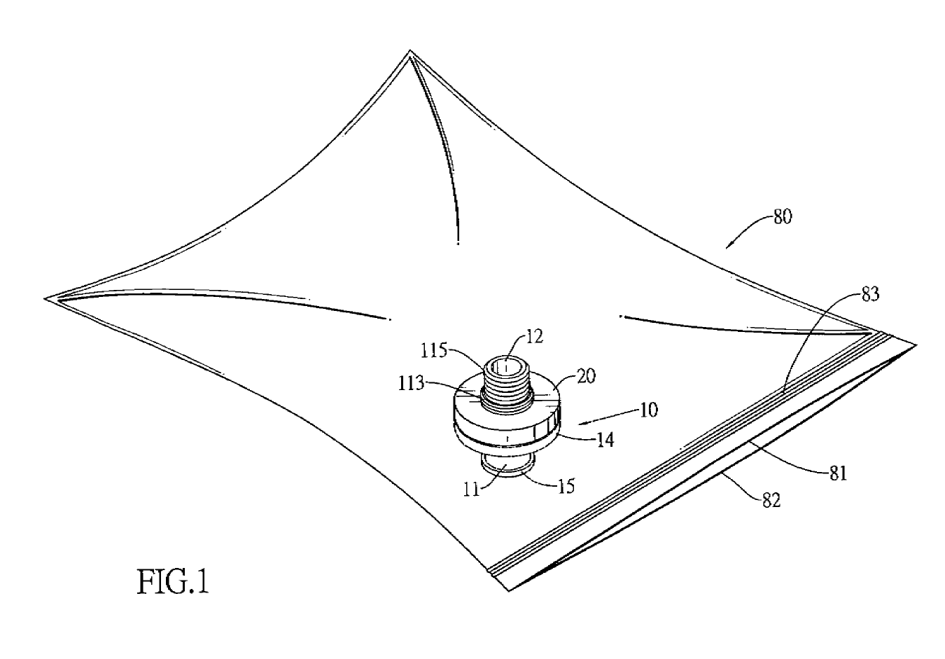

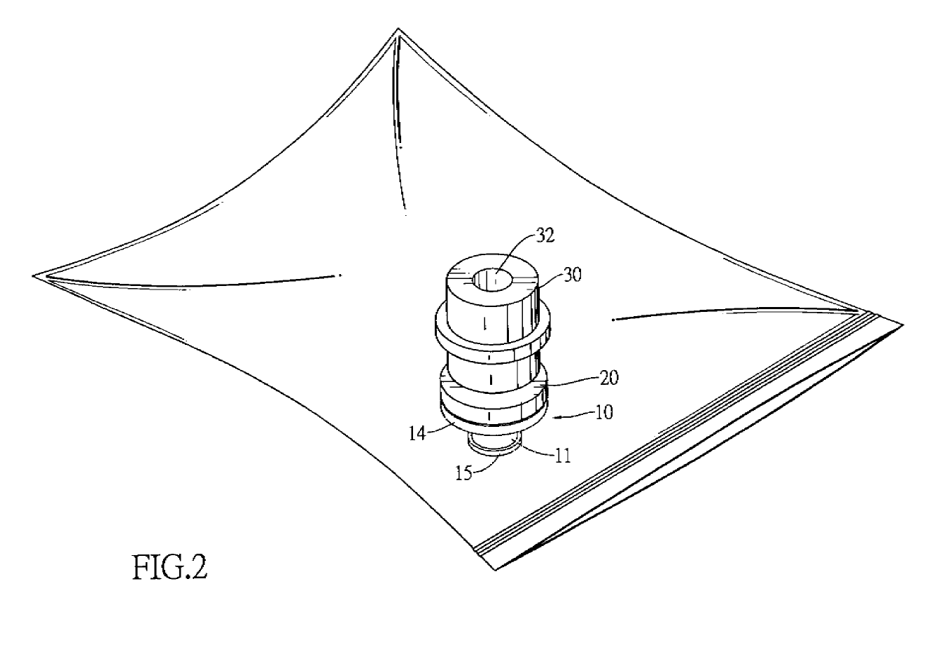

With reference to FIGS. 1 and 2, a vacuum valve device in accordance with the present invention is used with and mounted detachably on a bag (80) that is un-permeable to water or gas and may be made of plastic. The bag (80) has a cavity, an opening, two sheets (81, 82) and a seal (83). The cavity is defined in the bag (80). The seal (83) is mounted on the opening and selectively seals the opening.

The vacuum valve device is mounted on one sheet (81) of the bag (80) and has a base (10)), a clip (20) and all adapter sleeve (30).

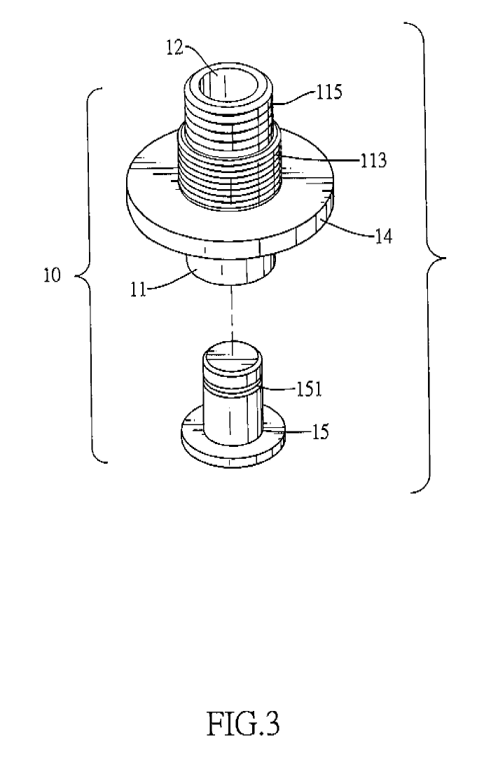

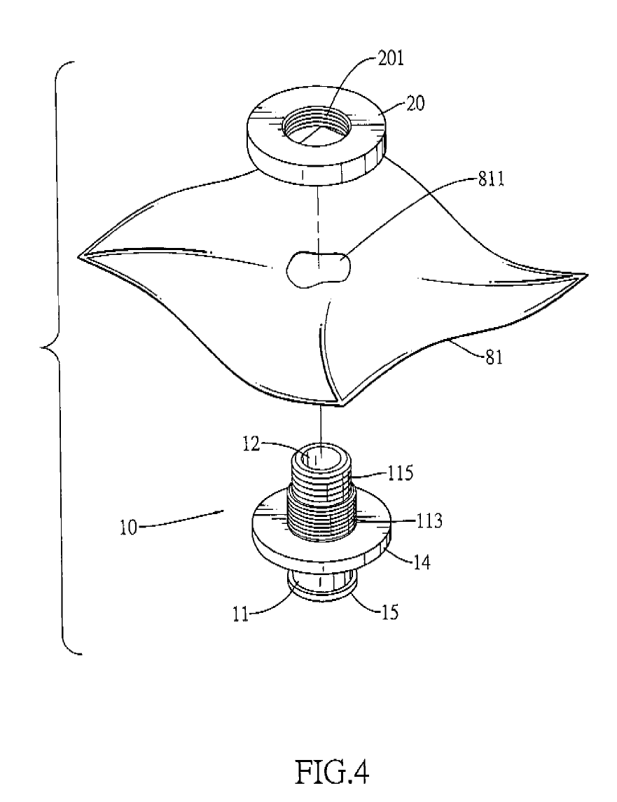

With reference to FIGS. 3 and 4, the base (10) has a tube (11) and a valve shaft (15).

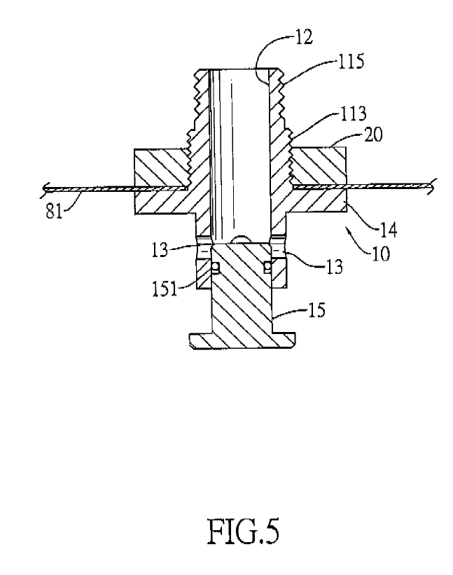

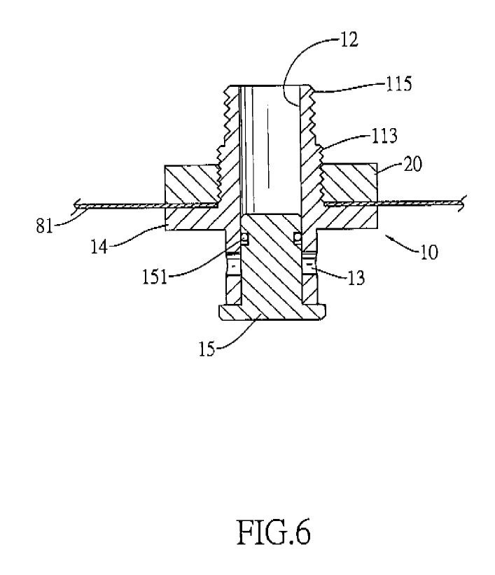

The tube (11) is mounted on and penetrates through the sheet (81) or the bag (80) having a through hole (8L 11) defined through the sheet (81). With further reference to FIGS. 5 and 6, the tube (11) may be connected to a vacuum pump and has an inner open end, an outer open end, a central hole (12), at least one outlet hole (13), a clipping flange (14), a first outer thread (113) and a second outer thread (115). The central hole (12) is defined axially through the tube (11), communicates with the inner and outer open ends and has an inner surface. The all least one outlet hole (13) is defined transversely in the tube (11) and communicates with the central hole (12). The clipping flange (14) is annular, is formed on and extends radially outwardly from the tube (11) and is held inside the cavity in the bag (80). The first outer thread (113) is formed on the tube (11) adjacent to the clipping flange (14). The second outer thread (115) is formed on the tube (11) between the outer open end and the first outer thread (113).

The valve shaft (15) is mounted slidably in the inner open end of the tube (11), selectively seals the at least one outlet hole (13) and has an inner end, an outer end and an O-ring (151). The (O-ring (151) is mounted around the valve shaft (15) and hermetically contacts the inner surface of the central hole (12) to seal the at least one outlet hole (13) after the valve shaft (15) retracts in the central hole (12).

The clip (20) is annular, is mounted detachably around the tube (11) of the base (10) adjacent to the outer open end, cooperates with the clipping flange (14) to hermetically clip the sheet (81) of the bag (80) between the clip (20) and the clipping flange (14) aid seal the through hole (811). The clip (14) has a mounting hole and an inner thread (201). The mounting hole is defined axially through the clip (20), allows the tube (11) to be mounted through the mounting hole and has an inner surface. The inner thread (201) is formed on the inner surface of the mounting hole and engages detachably with the first outer thread (113) to securely mount the clip (20) on the base (10).

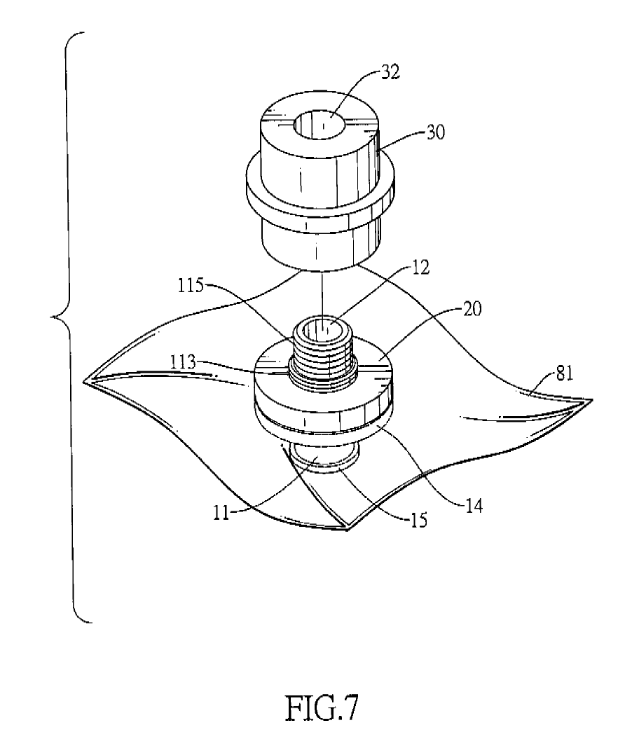

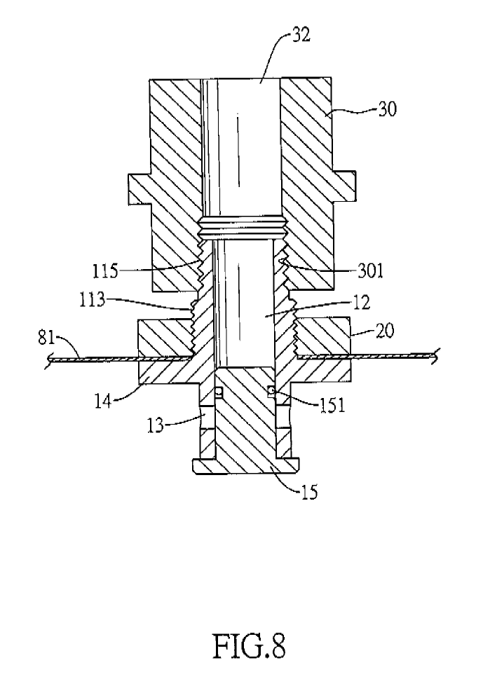

With reference to FIGS. 7 and 8, the adapter sleeve (30) is mounted detachably on the tube adjacent to the clip (20) and has a distal open end, a proximal open end, a mounting hole (32) and an inner thread (301). A diameter of the distail open end is different from that of the proximal open end so the distal open end may tightly hold a pipe from the vacuum pump. The mounting hole (32) s defined axially through the adapter sleeve (30), communicates with the distal and proximial open ends and has an inner surface. The inner thread (301) is formed on the inner surface of the mounting hole (32) in the adapter sleeve (30) adjacent to the distal open end and engages detachably with the second outer thread (115) on the tube (11).

With reference to FIGS. 1 and 5, the outer open end of the tube (11) penetrates through the through hole (811) in the sheet (81) of the bag (80) when the vacuum valve device is mounted to the bag (80). Then, the seal (83) on the bag (80) closes to seal the opening. Then, the clip (20) is mounted around the tube (11) and cooperates with the clipping flange (14) on the tube (11) to hermetically clip the sheet (81) and seal the through hole (811). Then, the valve shaft (15) extends out of the central hole (12) to communicate the at least one outlet hole (13) with the central hole (12). The adapter sleeve (30) maybe mounted on the tube: (11). Then, the pipe of the vacuum pump is connected to the adapter sleeve (30) or is connected directly to the outer open end of the tube (11) and pumps inside air out of the bag (80). After air is entirely pumped out of the bag (80), the valve shaft (15) is retracted in the central hole (12) to seal the at least one outlet hole (13) and completely seal the bag (30).

The vacuum valve device can detach from the bag (80) to be reused on another bag when the present bag (80) is damaged or smells due to the foods in the bag (80). People do not need to pay much money for a new vacuum valve device as the present bag (80) is damaged. Therefore, the vacuum valve device is economical and marketable.

Even though numerous characteristics and advantages of the present 9 invention have been set forth in the foregoing description, together with details of the structure and function or the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A vacuum valve device for a bag comprising:
a base having
a tube having
an inner open end;
an outer open end;
a central hole defined axially through the tube, communicating with the inner open end and the outer open end;
at least one outlet hole defined transversely in the tube and communicating with the central hole;
a clipping flange being annular, formed on and extending radially outward from the tube; and
a valve shaft mounted slidably in the inner open end of the tube, selectively seating the at least one outlet hole and having an inner end and an outer end; and
a clip being annular, mounted detachably around the tube of the base adjacent to the outer open end, cooperating with the clipping flange to be adapted to hermetically clip a sheet of the bag and having a mounting hole defined axiailly through the clip, through which the tube is mounted and having an inner surface.

2. The vacuum valve device as claimed in claim 1, wherein:
the tube further has a first outer thread formed on the tube adjacent to the clipping flange; and
the clip further has an inner thread formed on the inner surface of the mounting hole and engaging detachably with the first outer thread.

3. The vacuum valve device as claimed in claim 2 further comprising an adapter sleeve mounted detachably on the tube adjacent to the clip and having
a distal open end having a diameter;
a proximal open end and a diameter of a proximal open end being different from that of the distal open end; and
a mounting hole defined axially through the adapter sleeve, communicating with the distal and proximal open ends and having an inner surface.

4. The vacuum valve device as claimed in claim 3, wherein:
the tube further has a second outer thread formed on the tube between the outer open end and the first outer thread; and
the adapter sleeve further has an inner thread formed on the inner surface of the mounting hole in the adapter sleeve adjacent to the distal open end and engaging detachably with the second outer thread on the tube.

5. The vacuum valve device as claimed in claim 4, wherein the valve shaft has an O-ring mounted around the valve shaft and hermetically contacting the inner surface of the central hole to seal the at least one outlet hole after the valve shaft retracts in the central hole.
